(19) United States
(12) Patent Application Publication
(10) Pub. No.: US 2026/0213502 A1
(43) Pub. Date: Jul. 23, 2026

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Daiji YOSHITO, Osaka (JP); Hideo TAKAHASHI, Osaka (JP); Yoshinori IKAI, Osaka (JP)

(21) Appl. No.: 19/141,317

(22) PCT Filed: Dec. 15, 2023
(86) PCT No.: PCT/JP2023/044976

§ 371 Date: Jun. 20, 2025

(30) Foreign Application Priority Data
Dec. 22, 2022 (JP) 2022-205221

(51) Int. Cl. H02B 1/20; B60L 50/64; B60R 16/02; H01M 10/48; H01M 50/249; H01M 50/298; H01M 50/507; H01M 50/519; H02B 1/26

(52) U.S. Cl. CPC H02B 1/20; H01M 10/482; H01M 10/486; H01M 50/249; H01M 50/298; H01M 50/507; H01M 50/519; H02B 1/26; B60L 50/64; B60R 16/0215; H01M 2220/20

(57) ABSTRACT

A main line accommodating portion for accommodating a main line integrally configured by bundling the plurality of voltage detection lines and a fixing portion for fixing the main line to the protector are provided inside the protector. The main line includes a straight portion extending in a first direction and an extra length portion formed by contracting a part of the straight portion in the first direction. The main line accommodating portion includes a straight routing region for routing the straight portion, a lead-out opening for leading out the main line from inside of the protector and an extra length routing region for routing the extra length portion by being disposed between the lead-out opening and the fixing portion.

### TECHNICAL FIELD

The present disclosure relates to a wiring module.

### BACKGROUND

Conventionally, a wiring module described in Japanese Patent Laid-Open Publication No. 2019-036471 (Patent Document 1 below) is, for example, known as a wiring module to be installed in a vehicle such as an electric vehicle or a hybrid vehicle. This wiring module is provided with an insulating protector, busbars for connecting electrodes of pairs of adjacent power storage elements and detection wires connected to the busbars, and placed on the upper surface of a power storage element group.

The insulating protector includes a terminal accommodating portion for accommodating a plurality of the busbars and a wire accommodating portion for accommodating a plurality of the detection wires extending from the plurality of busbars. The plurality of detection wires are bent rearward in the wire accommodating portion and extend outward through a wire extension opening formed in a rear wall of the wire accommodating portion. The plurality of detection wires extending outward from the insulating protector are bundled and become an integrally configured main line, and a connector is provided on an extension end part of the main line. The connector is connectable to a mating connector provided on an external device. An extra length portion is provided in the main line to perform a connecting operation of the connector and the mating connector.

### PRIOR ART DOCUMENT

### Patent Document

Patent Document 1: JP 2019-036471 A

### SUMMARY OF THE INVENTION

### Problems to be Solved

In the above wiring module, the extra length portion protruding to the outside of the insulating protector through the wire extension opening is desirably provided to easily connect the connector to the mating connector. In that case, a space required for the arrangement of the wiring module requires a space for arranging the extra length portion in addition to a space for arranging the insulating protector. However, in recent years, it has been desired to narrow a space for arranging a wiring module. Thus, it may be difficult in some cases to ensure a space for arranging an extra length portion.

The present disclosure was completed on the basis of the above situation and aims to reduce protrusion amounts of a connector and a main line while providing an extra length portion.

### Means to Solve the Problem

The present disclosure is directed to a wiring module to be attached to a power storage element group configured by arranging a plurality of power storage elements including electrode terminals in a first direction, the wiring module being provided with a plurality of busbars, a plurality of circuit boards, a plurality of voltage detection lines, a protector for holding the plurality of busbars, the plurality of circuit boards and the plurality of voltage detection lines, and a connector located outside the protector, the busbar being connected to the electrode terminal, the circuit board being connected to the busbar, one end of the voltage detection line being connected to the circuit board and the other end of the voltage detection line being connected to the connector, a main line accommodating portion for accommodating a main line integrally configured by bundling the plurality of voltage detection lines and a fixing portion for fixing the main line to the protector being provided inside the protector, the main line including a straight portion extending in the first direction and an extra length portion formed by contracting a part of the straight portion in the first direction, and the main line accommodating portion including a straight routing region for routing the straight portion, a lead-out opening for leading out the main line from inside of the protector and an extra length routing region for routing the extra length portion by being disposed between the lead-out opening and the fixing portion.

### Effect of the Invention

According to the present disclosure, it is possible to reduce protrusion amounts of a connector and a main line while providing an extra length portion.

### BRIEF DESCRIPTION OF THE DRAWINGS

FIG. 1 is a schematic diagram showing a vehicle installed with a power storage module according to an embodiment.

FIG. 2 is a plan view of a wiring module and a power storage element group.

FIG. 3 is a plan view of the wiring module and the power storage element group except covers.

FIG. 4 is an enlarged plan view enlargedly showing a part A of FIG. 3.

FIG. 5 is a section along B-B of FIG. 4.

FIG. 6 is a section along C-C of FIG. 4.

FIG. 7 is a section along D-D of FIG. 4.

FIG. 8 is an enlarged plan view showing the part A except a part of a main line and a connector of FIG. 4.

FIG. 9 is an enlarged plan view showing a state where an extra length portion of FIG. 4 is extended and the connector is pulled out to outside.

### DETAILED DESCRIPTION TO EXECUTE THE INVENTION

### Description of Embodiments of Present Disclosure

First, embodiments of the present disclosure are listed and described.

(1) The wiring module of the present disclosure is to be attached to a power storage element group configured by arranging a plurality of power storage elements including electrode terminals in a first direction, and provided with a plurality of busbars, a plurality of circuit boards, a plurality of voltage detection lines, a protector for holding the plurality of busbars, the plurality of circuit boards and the plurality of voltage detection lines, and a connector located outside the protector, the busbar being connected to the electrode terminal, the circuit board being connected to the busbar, one end of the voltage detection line being connected to the circuit board and the other end of the voltage detection line being connected to the connector, a main line accommodating portion for accommodating a main line integrally configured by bundling the plurality of voltage detection lines and a fixing portion for fixing the main line to the protector being provided inside the protector, the main line including a straight portion extending in the first direction and an extra length portion formed by contracting a part of the straight portion in the first direction, and the main line accommodating portion including a straight routing region for routing the straight portion, a lead-out opening for leading out the main line from inside of the protector and an extra length routing region for routing the extra length portion by being disposed between the lead-out opening and the fixing portion.

In connecting the connector to a mating connector of an external device, the extra length portion is elongated in the first direction and the main line can be pulled out to the outside of the protector through the lead-out opening by pulling the connector in the first direction. Since the main line pulled out through the lead-out opening functions as an extra length, the connector is more easily connected to the mating connector. Further, after the connector is connected to the mating connector, the extra length portion of the main line can be accommodated in the extra length routing region by pushing the main line in the first direction from the outside of the protector.

Since the main line is fixed to the protector by the fixing portion, it can be avoided that a tensile stress is transferred to each voltage detection line when the main line is pulled out through the lead-out opening by pulling the connector. Further, since vibration can be suppressed by the fixing portion when the vibration is transmitted to the main line from a vehicle, the transmission of that vibration to each voltage detection line can be suppressed.

Since the main line accommodating portion including the extra length routing region for routing the extra length portion of the main line is provided inside the protector, the connector can be arranged near the lead-out opening outside the protector. Further, it is possible to reduce protrusion amounts of the connector and the main line when the main line is pulled out through the lead-out opening by pulling the connector. That is, the protrusion amounts of the connector and the main line can be reduced while the extra length portion is provided. Therefore, a space required to arrange the wiring module can be reduced.

(2) Preferably, the protector includes a busbar accommodating portion for accommodating the plurality of busbars and a board accommodating portion for accommodating the circuit boards by being disposed between the main line accommodating portion and the busbar accommodating portion and the extra length portion has a curved shape bulging in a direction toward the busbar accommodating portion, and the extra length routing region is located between the fixing portion and the circuit board.

The extra length routing region can be set, effectively utilizing a space between the fixing portion and the circuit board. By doing so, the wiring module can be reduced in size, a battery pack can be reduced in size and an energy density of the battery pack can be improved by bringing the board accommodating portion and the main line accommodating portion closer.

(3) Preferably, the plurality of circuit boards are accommodated in the board accommodating portion, and the extra length routing region is located between the N^{th} circuit board and the (N+1)^{th} circuit board counted from the lead-out opening side.

Also when the plurality of circuit boards are accommodated in the board accommodating portion, the extra length routing region can be set, effectively utilizing a space between the N^{th} circuit board and the (N+1)^{th} circuit board.

(4) Preferably, the wiring module is further provided with a temperature detection line, the plurality of circuit boards include a first circuit board to be connected to the busbar and a second circuit board having a temperature measuring element mounted thereon, a plurality of the first circuit boards and the second circuit board are accommodated in the board accommodating portion, one end of the temperature detection line is connected to the second circuit board and the other end of the temperature detection line is connected to the connector, the main line is integrally configured by bundling the plurality of voltage detection lines and the temperature detection line, a routing rib projecting in a second direction orthogonal to the first direction is provided on a bottom wall of the main line accommodating portion, and the main line is routed away from the bottom wall of the main line accommodating portion in the second direction by the routing rib and the temperature detection line is routed between the main line and the bottom wall of the main line accommodating portion in the second direction.

If the main line is pulled out from the inside of the protector with the temperature detection line and the main line both accommodated in the main line accommodating portion, the temperature detection line is possibly dragged and pulled by the main line and a load is possibly applied to a connected part of the temperature detection line and the second circuit board.

According to the above configuration, since the routing rib is provided on the bottom wall of the main line accommodating portion, the main line is placed on the routing rib and routed at a position separated from the bottom wall of the main line accommodating portion. On the other hand, since being routed between the main line and the bottom wall of the main line accommodating portion in the second direction, the temperature detection line can be accommodated in the main line accommodating portion without contacting the main line. Therefore, it can be suppressed that the temperature detection line is dragged and pulled by the main line when the main line is pulled out from the inside of the protector, wherefore the application of a load to the connected part of the temperature detection line and the second circuit board can be suppressed.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### Embodiment

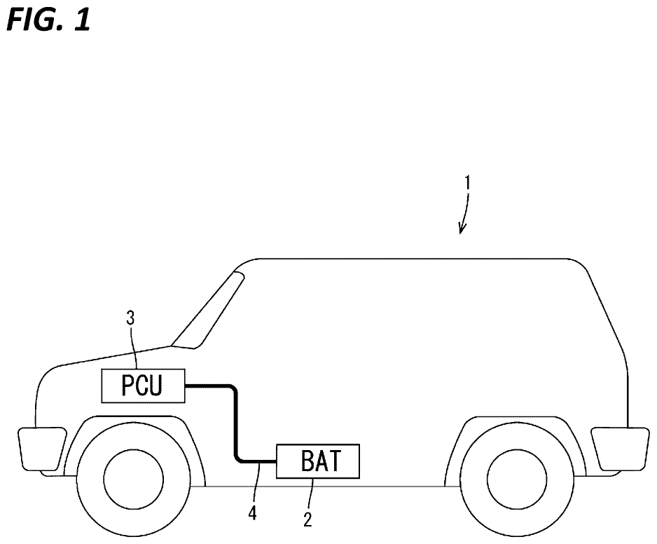

One embodiment of the present disclosure is described with reference to FIGS. 1 to 9. A power storage module 10 provided with a wiring module 20 of this embodiment is, for example, applied to a power storage pack 2 installed in a vehicle 1 as shown in FIG. 1. The power storage pack 2 is installed in the vehicle 1 such as an electric vehicle or a hybrid vehicle and used as a drive source of the vehicle 1. In the following description, for a plurality of identical members, only some members may be denoted by a reference sign and the other members may not be denoted by the reference sign.

As shown in FIG. 1, the power storage pack 2 is disposed near a center of the vehicle 1. A PCU (Power Control Unit) 3 is disposed in a front part of the vehicle 1. The power storage pack 2 and the PCU 3 are connected by a wiring harness 4. The power storage pack 2 and the wiring harness 4 are connected by an unillustrated connector. The power storage pack 2 includes the power storage module 10 provided with a plurality of power storage elements 11. In the following description, a direction indicated by an arrow Z is referred to as an upward direction, a direction indicated by an arrow X is referred to as a forward direction and a direction indicated by an arrow Y is referred to as a leftward direction except in FIG. 1.

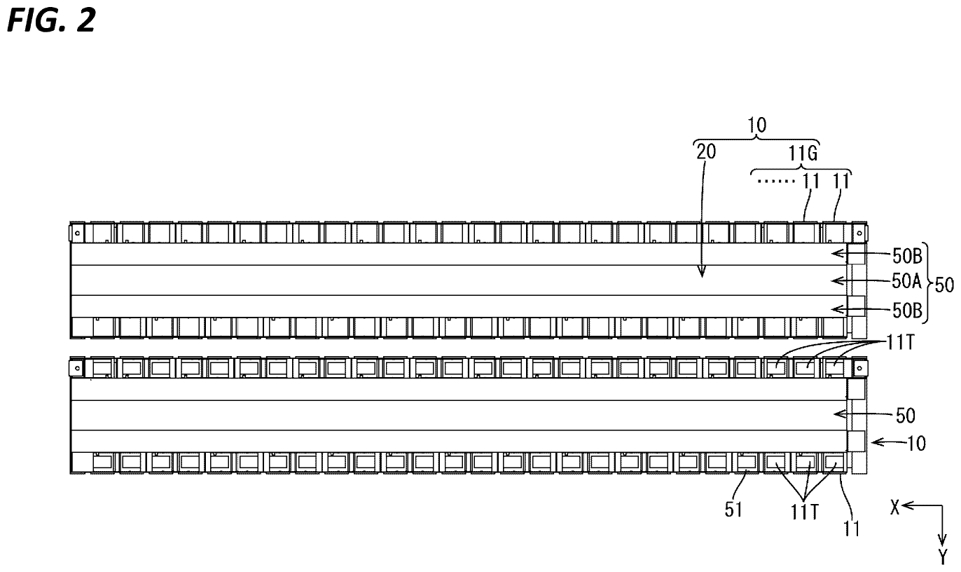

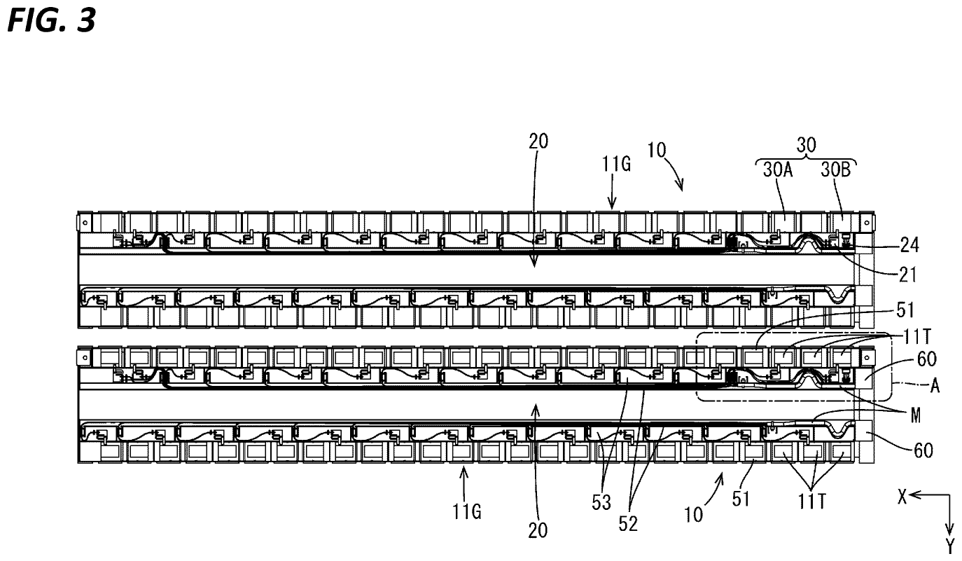

As shown in FIG. 2, the power storage module 10 has a rectangular plan view shape long in a front-rear direction (an example of a first direction) and short in a lateral direction (an example of a third direction), and a pair of power storage modules 10 are disposed side by side in the lateral direction. The power storage module 10 is provided with a power storage element group 11G configured by arranging the power storage elements 11 in the front-rear direction and the wiring module 20 to be mounted on the upper surface of the power storage element group 11G. The power storage element 11 has a flat rectangular parallelepiped shape and a power storage component is accommodated inside. In the left power storage module 10 in FIGS. 2 and 3, a state where busbars 30 are removed is shown. The power storage element 11 includes a pair of electrode terminals 11T at a position near a right end part and a position near a left end part on an upper surface. One of the pair of electrode terminals 11T is a positive electrode, and the other is a negative electrode.

### Wiring Module

As shown in FIGS. 2 to 4, the wiring module 20 is provided with the busbars 30 to be connected to the electrode terminals 11T of the power storage elements 11, first circuit boards 21 to be connected to the busbars 30, a second circuit board 24 having a temperature measuring element 26 mounted thereon, voltage detection lines 40 to be connected to the first circuit boards 21, temperature detection lines 41 to be connected to the second circuit board 24, and a protector 50 for holding the busbars 30, the first circuit boards 21, the second circuit board 24, the voltage detection lines 40 and the temperature detection lines 41. Note that the first and second circuit boards 21, 24 correspond to “circuit boards”.

### Busbars

The busbars 30 are constituted by metal plate members and have a rectangular shape in a plan view. The busbars 30 include connection busbars 30A for connecting the electrode terminals 11T adjacent in a stacking direction (front-rear direction) of the plurality of power storage elements 11 and output busbars 30B to be connected to the electrode terminals 11T of the power storage element 11 disposed in an end part in the stacking direction. The output busbar 30B connects total positive electrodes or total negative electrodes of the plurality of power storage elements 11 and an external device. The busbars 30 and the electrode terminals 11T are connected by welding or the like. The busbars 30 are accommodated in busbar accommodating portions 51 of the protector 50 to be described later.

### First Circuit Board

The first circuit board 21 is a flexible board in this embodiment and configured by forming electrically conductive paths on a surface of a flexible insulating sheet by a printed wiring technique. The first circuit board 21 is provided with a board body 22 and an extending portion 23 extending from the board body 22. The board body 22 has a substantially rectangular shape in a plan view. The board body 22 is fixed to a placing surface 54 of the protector 50 to be described later. Although not described in detail, the board body 22 is, for example, provided with an insertion hole, and a projection projecting from the placing surface 54 is inserted into this insertion hole. The board body 22 is provided with wire lands 22A disposed on one ends of the electrically conductive paths. The wire land 22A is connected to the voltage detection line 40 by soldering or the like.

The extending portion 23 is U-shaped in a plan view and configured to be stretchable. By providing the extending portion 23, an end part (tip part) of the extending portion 23 on a side opposite to the board body 22 is allowed to be displaced by a predetermined dimension with respect to the board body 22. The other ends (not shown) of the electrically conductive paths are disposed on the tip part of the extending portion 23. The other ends of the electrically conductive paths are electrically connected to the busbar 30 via a small metal piece 15. Although not shown, a fuse or the like may be provided in the electrically conductive paths of the first circuit board 21.

### Second Circuit Board

The second circuit board 24 is a flexible board in this embodiment and configured by forming electrically conductive paths on a surface of a flexible insulating sheet by the printed wiring technique. The second circuit board 24 is provided with a board body 25 and the temperature measuring element 26 mounted on a land of the board body 25. The board body 25 is substantially T-shaped in a plan view. The board body 25 is fixed to the plating surface 54 of the protector 50 to be described later, similarly to the board body 22 of the first circuit board 21. The board body 25 is provided with wire lands 25A disposed on one ends of the electrically conductive paths. The wire land 25A is connected to the temperature detection lines 41 by soldering or the like. A thermistor, a platinum temperature measuring resistor or the like can be, for example, used as the temperature measuring element 26.

### Voltage Detection Lines, Temperature Detection Lines

Since the voltage detection lines 40 connected to the first circuit board 21 and the temperature detection lines 41 connected to the second circuit board 24 are similarly configured, the voltage detection lines 40 are described as a representative for the overlapping configuration. The voltage detection line 40 has a known configuration by covering a core wire formed by twisting a plurality of strands by an insulation coating. A main line M is integrally configured by bundling and taping a plurality of the voltage detection lines 40 and a plurality of the temperature detection lines 41 or accommodating these detection lines in a corrugated tube. The main line M is accommodated into a main line accommodating portion 52 of the protector 50 to be described later.

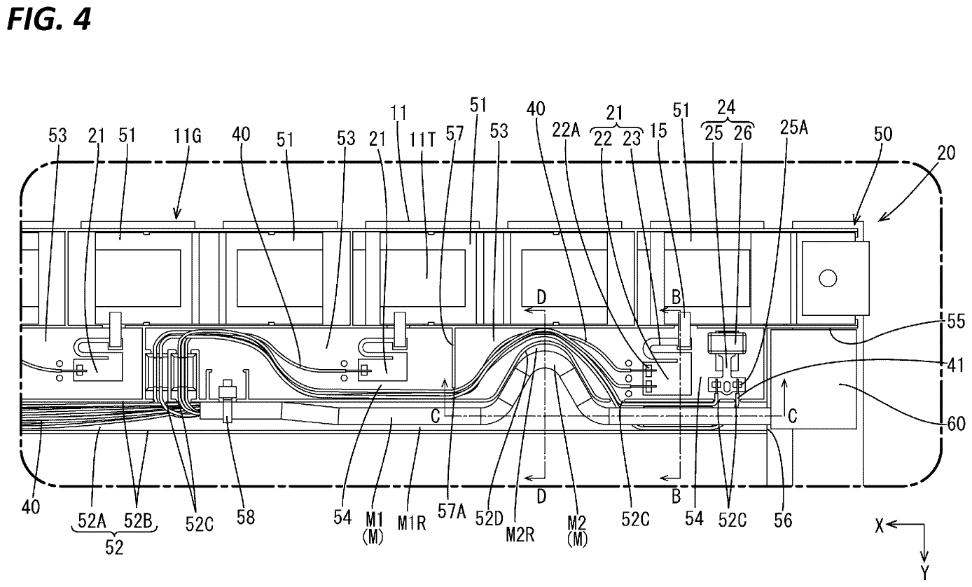

As shown in FIG. 4, the main line M includes a straight portion M1 extending in the front-rear direction and an extra length portion M2 formed by contracting a part of the straight portion M1 in the front-rear direction. The extra length portion M2 has a curved shape bulging rightward (in a direction toward the busbar accommodating portion 51).

The plurality of voltage detection lines 40 are connected to a connector 60 in an end part on a side opposite to the first circuit boards 21. This connector 60 is connected to a mating connector provided in an external ECU (Electronic Control Unit) or the like. The ECU is mounted with a microcomputer, elements and the like, and has a known configuration provided with functions of detecting a voltage, a current, a temperature and the like of each power storage element 11 and controlling the charge/discharge of each power storage element 11.

A connector accommodating portion 55 for accommodating the connector 60 is provided in a rear end part of the protector 50. The connector accommodating portion 55 is a space formed by cutting a part of the protector 50. The rear end of the connector accommodating portion 55 is aligned with the rear end of the protector 50. With the connector 60 accommodated in the connector accommodating portion 55, the rear end of the connector 60 does not protrude rearward from the rear end of the protector 50.

### Protector

The protector 50 is made of insulating synthetic resin. The protector 50 is provided with a protector body 50A and covers 50B for covering the protector body 50A from above. In this embodiment, two covers 50B (see FIG. 2) are provided for one protector body 50A.

### Protector Body

The protector body 50A is in the form of a tray. As shown in FIG. 3, the protector body 50A is provided with a plurality of the busbar accommodating portions 51 for accommodating the busbars 30, a pair of main line accommodating portions 52 for accommodating the main lines M, and a plurality of board accommodating portions 53 disposed between the busbar accommodating portions 51 and the main line accommodating portions 52. The busbar accommodating portions 51 are provided in both end parts in the lateral direction of the protector body 50A. The busbar accommodating portions 51 are frame-shaped, and arranged side by side in a row in the front-rear direction and provided in two rows separated in the lateral direction.

### Main Line Accommodating Portions, Lead-Out Opening

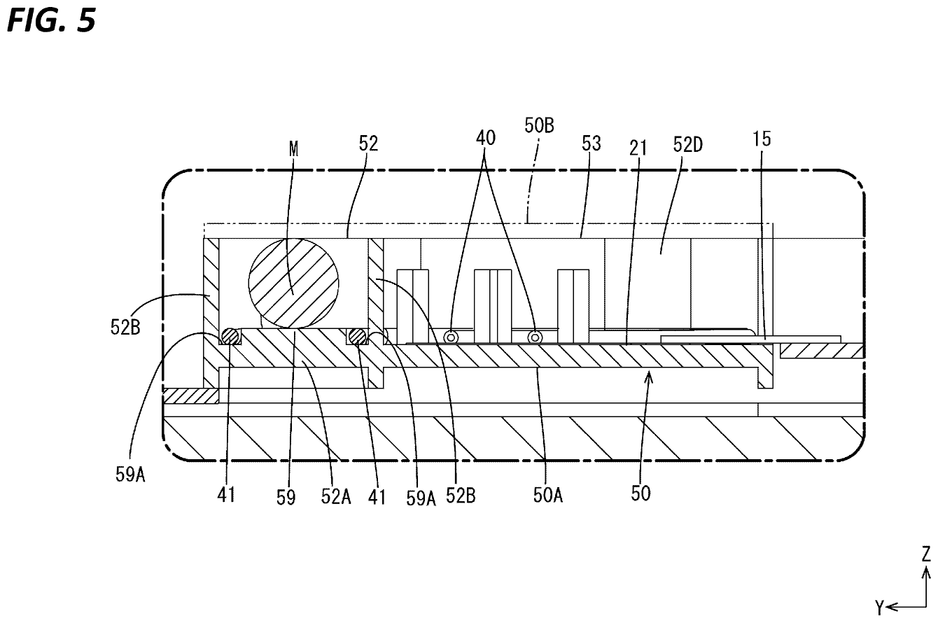

Two main line accommodating portions 52 are provided at positions near a lateral central part of the protector body 50A. The main line accommodating portion 52 is groove-like and extends in the front-rear direction. As shown in FIG. 5, the main line accommodating portion 52 includes a bottom wall 52A and a pair of side walls 52B rising upward from both left and right end edges of the bottom wall 52A. As shown in FIG. 4, the side wall 52B of the main line accommodating portion 52 on the side of the board accommodating portions 53 is formed with a plurality of cut portions 52C. The voltage detection lines 40 and the temperature detection lines 41 are insertable between the board accommodating portions 53 and the main line accommodating portion 52 via the cut portions 52C. A lead-out opening 56 is provided in a rear end part of the main line accommodating portion 52. The main line M can be inserted and withdrawn between the main line accommodating portion 52 and the outside of the protector 50 via the lead-out opening 56.

### Board Accommodating Portions

The board accommodating portions 53 are frame-shaped, and arranged side by side in a row in the front-rear direction and provided in two rows separated in the lateral direction. A pair of adjacent board accommodating portions 53 are partitioned by a partition wall 57. One first circuit board 21 is accommodated in one board accommodating portion 53. The second circuit board 24 is accommodated only in the rearmost board accommodating portion 53, and both the first and second circuit boards 21, 24 are accommodated in this board accommodating portion 53. The board accommodating portions 53 and the main line accommodating portion 52 are partitioned by the right side wall 52B, and a part of the right side wall 52B serves as a curved wall 52D formed by being curved toward the busbar accommodating portion 51. The curved wall 52D is formed only in the rearmost board accommodating portion 53. The voltage detection lines 40 extending from the first circuit board 21 and the temperature detection lines 41 extending from the second circuit board 24 extend toward the main line accommodating portion 52 and are led out to the second board accommodating portion 53 via an opening 57A formed in the partition wall 57 from behind after extending toward the busbar accommodating portion 51 along the curved wall 52D.

One first circuit board 21 is accommodated in the second board accommodating portion 53 from behind, and the voltage detection lines 40 extending from this first circuit board 21 extend toward the main line accommodating portion 52 and are led out to the main line accommodating portion 52 via the cut portions 52C of the side wall 52B after joining the voltage detection lines 40 and the temperature detection lines 41 led out from the rearmost board accommodating portion 53.

### Fixing Portion, Straight Routing Region, Extra Length Routing Region

The voltage detection lines 40 and the temperature detection lines 41 led out from the second board accommodating portion 53 from behind are routed rearward after joining the voltage detection lines 40 led out from the third and subsequent board accommodating portions 53 from behind. The joined voltage detection lines 40 and temperature detection lines 41 are bundled into one by taping or the like to form the main line M, and are routed rearward as the main line M.

The main line M is fixed to the protector 50 by a fixing portion 58. The fixing portion 58 is, for example, constituted by a zip tie and fixed to the protector 50 by being wound on the main line M. The fixing portion 58 is provided behind and adjacent to the cut portion 52C allowing communication between the second board accommodating portion 53 from behind and the main line accommodating portion 52. Therefore, the front end of the main line M is located between this cut portion 52C and the fixing portion 58.

The main line accommodating portion 52 includes a straight routing region MIR for routing the straight portion M1, and an extra length routing region M2R for routing the extra length portion M2 by being disposed between the lead-out opening 56 and the fixing portion 58. Since the main line accommodating portion 52 is provided inside the protector 50, the straight routing region MIR and the extra length routing region M2R are also located inside the protector 50. The extra length routing region M2R is, for example, located between the first circuit board 21 arranged between the fixing portion 58 and the lead-out opening 56 and the fixing portion 58. Further, the extra length routing region M2R may be located between the N^{th} circuit board and the (N+1)^{th} circuit board counted from the side of the lead-out opening 56. Note that “N” is an integer. For example, the extra length routing region M2R is located between the fixing portion 58 and the first first circuit board 21 counted from the side of the lead-out opening 56, more particularly located between the first first circuit board 21 and the second first circuit board 21 counted from the side of the lead-out opening 56. The extra length routing region M2R of this embodiment is formed, effectively utilizing an extra space located between the partition wall 57 and the first circuit board 21 in the rearmost board accommodating portion 53.

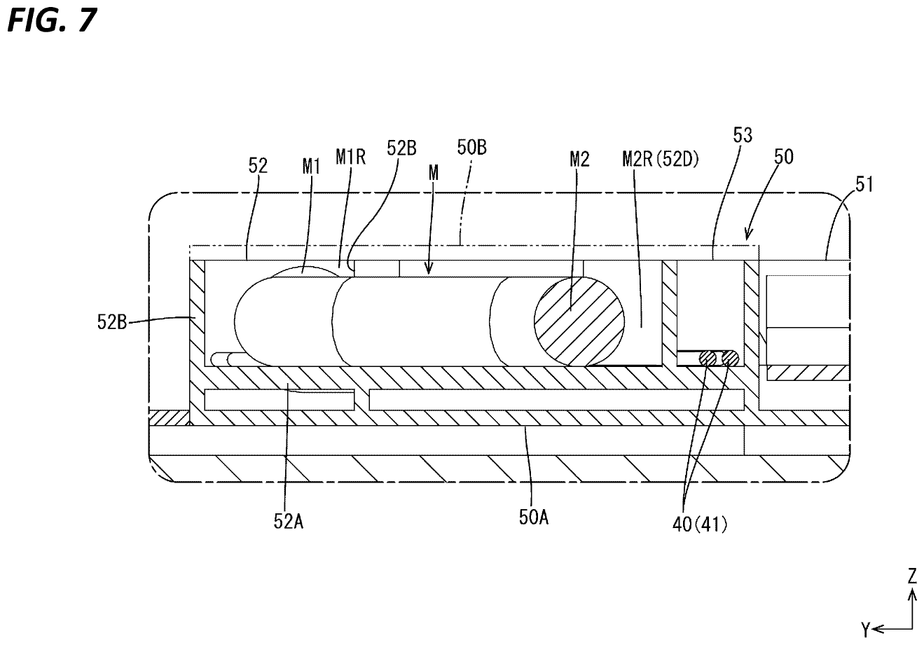

The extra length portion M2 of the main line M is located in the extra length routing region R2R and routed in a chevron shape along the curved wall 52D when the connector 60 is accommodated in the connector accommodating portion 55. As shown in FIG. 7, a top of the extra length portion M2 is located closer to the busbar accommodating portion 51 than a center in the lateral direction of the extra length routing region M2R. As a result, the board accommodating portion 53 is narrowed in the lateral direction near the top of the extra length portion M2. Further, although being suddenly bent to generate a reaction force in the extra length routing region M2R, the main line M is surrounded in the vertical direction (an example of a second direction) by the protector body 50A and the cover 50B, wherefore the main line M is assumed not to protrude to the outside of the protector 50.

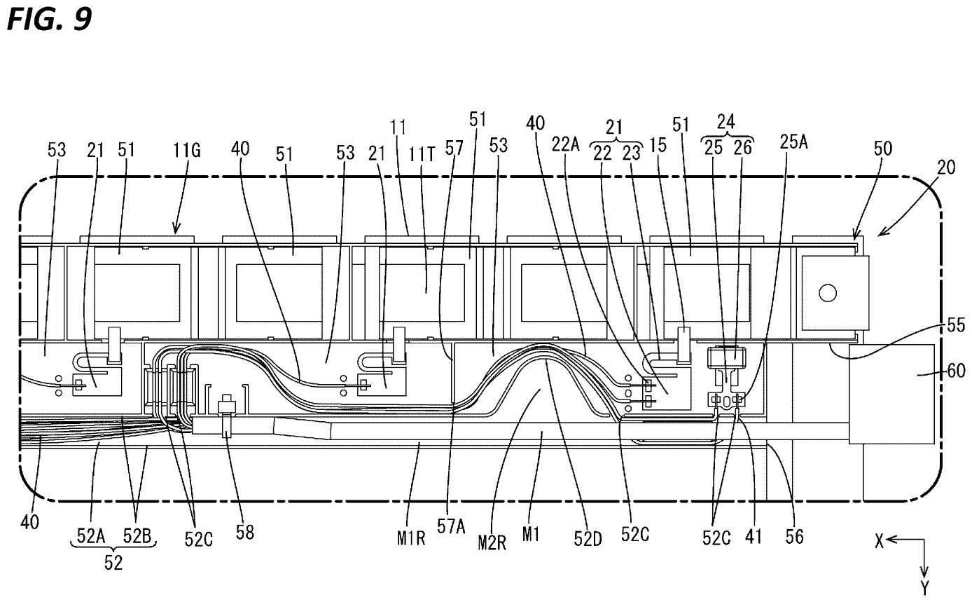

As shown in FIG. 9, with the connector 60 pulled rearward and protruding rearward from the connector accommodating portion 55, the extra length portion M2 becomes linear by being pulled and the main line M is constituted only by the straight portion M1 in the main line accommodating portion 52. In this way, since the connector 60 and a part of the main line M protrude rearward from the lead-out opening 56 of the protector 50 and freely move, a connecting operation to the mating connector can be performed. Further, since the main line M is fixed by the fixing portion 58, a tensile stress is not transferred to each voltage detection line 40 and each temperature detection line 41 when the main line M is pulled rearward.

In this embodiment, as shown in FIG. 3, the wiring module 20 is long in the front-rear direction, and all the voltage detection lines 40 are routed toward the connector 60. Considering dimensional tolerances, assembly tolerances and the like of each voltage detection line 40, the extra length portion M2 is an essential configuration to absorb stacked tolerances of these. Since such an extra length portion M2 is provided inside the protector 50, the wiring module 20 can be reduced in size, a battery pack can be reduced in size and, consequently, an energy density of the battery pack can be improved.

### Routine Rib

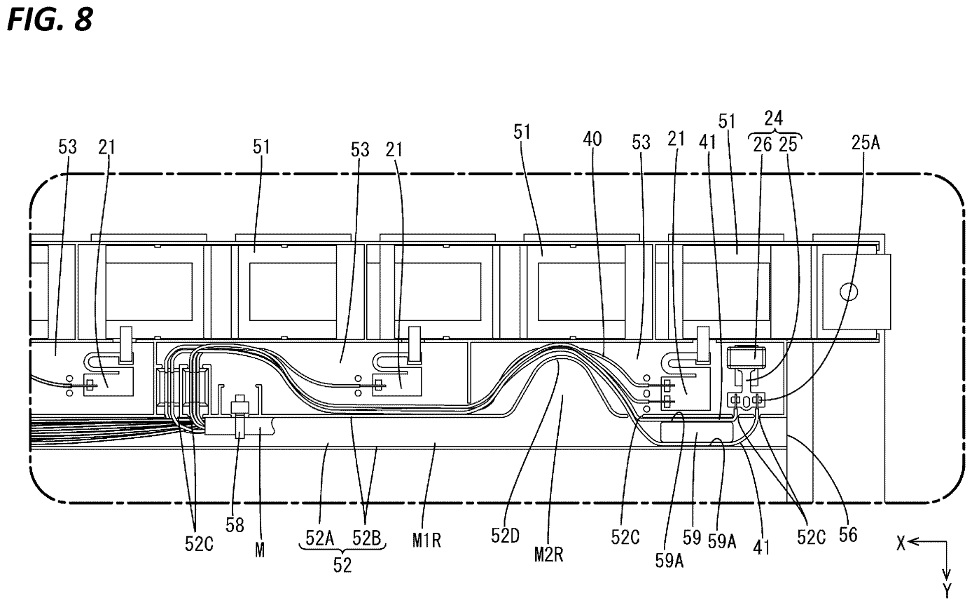

As shown in FIG. 8, a routing rib 59 is provided on the bottom wall 52A of the main line accommodating portion 52. The routing rib 59 is located between the curved wall 52D and the second circuit board 24 in the front-rear direction. As shown in FIG. 5, the routing rib 59 is provided to project upward from the bottom wall 52A of the main line accommodating portion 52. The routing rib 59 is disposed to provide gaps between the both side walls 52B of the main line accommodating portion 52 and the routing rib 59. As a result, a detection line accommodation groove 59A is formed between the side surface of the routing rib 59 and the side wall 52B facing this side surface.

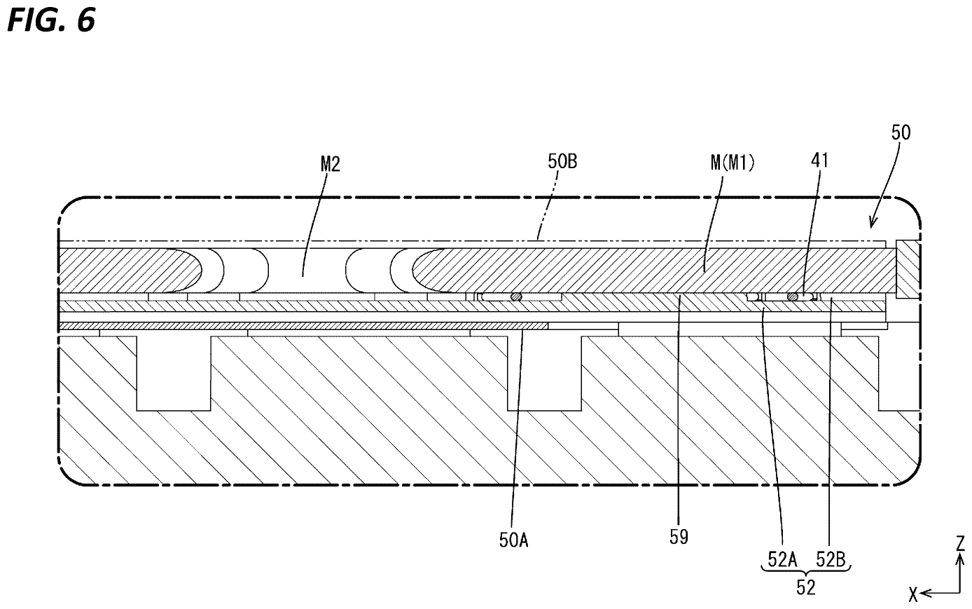

A pair of the detection line accommodation grooves 59A are provided on both left and right sides of the routing rib 59. The temperature detection lines 41 are accommodated in the detection line accommodation grooves 59A. On the other hand, as shown in FIGS. 5 and 6, the main line M is placed on the upper surface of the routing rib 59. The main line M is routed away from the bottom wall 52A of the main line accommodating portion 52 in the vertical direction by the routing rib 59, and the temperature detection lines 41 are routed between the main line M and the bottom wall 52A of the main line accommodating portion 52 in the vertical direction. By doing so, the contact of the main line M and the pair of temperature detection lines 41 can be avoided. Therefore, it can be avoided that the temperature detection lines 41 are pulled rearward by being dragged by the main line M and a load is applied to connected parts of the temperature detection lines 41 and the wire lands 25A when the main line M is pulled rearward by pulling the connector 60 rearward.

As shown in FIG. 8, a pair of the temperature detection lines 41 are respectively accommodated into the pair of detection line accommodation grooves 59A through a pair of the cut portions 52C located behind the routing rib 59, and are led out to the board accommodating portion 53 through a pair of the cut portions 52C located in front of the routing rib 59. Thereafter, the pair of temperature detection lines 41 are joined with a pair of the voltage detection lines 40, extend forward through the right side of the curved wall 52D, and are led out to the adjacent board accommodating portion 53 through the opening 57A of the partition wall 57.

### Functions and Effects of Embodiment

According to the embodiment, the following functions and effects are achieved.

The wiring module 20 according to the embodiment is to be attached to the power storage element group 11G configured by arranging the plurality of power storage elements 11 including the electrode terminals 11T in the front-rear direction, and provided with the plurality of busbars 30, the plurality of circuit boards, the plurality of voltage detection lines 40, the protector 50 for holding the plurality of busbars 30, the plurality of circuit boards and the plurality of voltage detection lines 40, and the connector located outside the protector 50. The busbar 30 is connected to the electrode terminal 11T, the circuit board is connected to the busbar 30, one end of the voltage detection line 40 is connected to the circuit board, and the other end of the voltage detection line 40 is connected to the connector 60. The main line accommodating portion 52 for accommodating the main line M integrally configured by bundling the plurality of voltage detection lines 40 and the fixing portion 58 for fixing the main line M to the protector 50 are provided inside the protector 50. The main line M includes the straight portion MI extending in the front-rear direction and the extra length portion M2 formed by contracting a part of the straight portion M1 in the front-rear direction. The main line accommodating portion 52 includes the straight routing region MIR for routing the straight portion M1, the lead-out opening 56 for leading out the main line M from the inside of the protector 50, and the extra length routing region M2R for routing the extra length portion M2 by being disposed between the lead-out opening 56 and the fixing portion 58.

In connecting the connector 60 to the mating connector of the external device, the extra length portion M2 can be elongated in the front-rear direction and the main line M can be pulled out to the outside of the protector 50 through the lead-out opening 56 by pulling the connector 60 in the front-rear direction. Since the main line M pulled out through the lead-out opening 56 functions as an extra length, the connector 60 is easily connected to the mating connector. Further, the extra length portion M2 of the main line M can be accommodated into the extra length routing region M2R by pushing in the main line M in the front-rear direction from the outside of the protector 50 after the connector 60 is connected to the mating connector.

Since the main line M is fixed to the protector 50 by the fixing portion 58, it can be avoided that a tensile stress is transferred to each voltage detection line 40 when the main line M is pulled out through the lead-out opening 56 by pulling the connector 60. Further, since vibration can be suppressed by the fixing portion 58 when the vibration is transmitted to the main line M from the vehicle 1, the transmission of that vibration to each voltage detection line 40 can be suppressed.

Since the main line accommodating portion 52 including the extra length routing region M2R for routing the extra length portion M2 of the main line M is provided inside the protector 50, the connector 60 can be arranged near the lead-out opening 56 outside the protector 50. Further, it is possible to reduce the protrusion amounts of the connector 60 and the main line M when the main line M is pulled out through the lead-out opening 56 by pulling the connector 60. That is, the protrusion amounts of the connector 60 and the main line M can be reduced while the extra length portion M2 is provided. Therefore, a space required to arrange the wiring module 20 can be reduced.

Preferably, the protector 50 includes the busbar accommodating portions 51 for accommodating the plurality of busbars 30 and the board accommodating portions 53 for accommodating the circuit boards by being disposed between the main line accommodating portions 52 and the busbar accommodating portions 51, the extra length portion M2 has the curved shape bulging in the direction toward the busbar accommodating portions 51, and the extra length routing region M2R is located between the fixing portion 58 and the circuit board.

The extra length routing region M2R can be set, effectively utilizing a space between the fixing portion 58 and the circuit board. By doing so, the wiring module 20 can be reduced in size, the battery pack can be reduced in size and the energy density of the battery pack can be improved by bringing the board accommodating portions 53 and the main line accommodating portions 52 closer.

Preferably, the plurality of circuit boards are accommodated in the board accommodating portion 53, and the extra length routing region M2R is located between the N^{th} circuit board and the (N+1)^{th} circuit board counted from the side of the lead-out opening 56.

Also when the plurality of circuit boards are accommodated in the board accommodating portion 53, the extra length routing region M2R can be set, effectively utilizing the space between the N^{th} first circuit board 21 and the (N+1)^{th} first circuit board 21.

Preferably, the wiring module is further provided with the temperature detection lines 41, the plurality of circuit boards include the first circuit boards 21 to be connected to the busbars and the second circuit board 24 having the temperature measuring element 26 mounted thereon. The plurality of first circuit boards 21 and the second circuit board 24 are accommodated in the board accommodating portions 53. One end of the temperature detection line 41 is connected to the second circuit board 24, and the other end of the temperature detection line 41 is connected to the connector 60. The main line M is integrally configured by bundling the plurality of voltage detection lines 40 and the plurality of temperature detection lines 41. The routing rib 59 projecting in the vertical direction orthogonal to the front-rear direction is provided on the bottom wall 52A of the main line accommodating portion 52, and the main line M is routed away from the bottom wall 52A of the main line accommodating portion 52 in the vertical direction by the routing rib 59. The temperature detection lines 41 are routed between the main line M and the bottom wall 52A of the main line accommodating portion 52 in the vertical direction.

If the main line M is pulled out from the inside of the protector 50 with the temperature detection lines 41 and the main line M both accommodated in the main line accommodating portion 52, the temperature detection lines 41 are possibly dragged and pulled by the main line M and a load is possibly applied to the connected parts of the temperature detection lines 41 and the second circuit board 24.

According to the above configuration, since the routing rib 59 is provided on the bottom wall 52A of the main line accommodating portion 52, the main line M is placed on the routing rib 59 and routed at the position separated from the bottom wall 52A of the main line accommodating portion 52. On the other hand, since being routed between the main line M and the bottom wall 52A of the main line accommodating portion 52 in the vertical direction, the temperature detection lines 41 can be accommodated in the main line accommodating portion 52 without contacting the main line M. Therefore, it can be suppressed that the temperature detection lines 41 are dragged and pulled by the main line M when the main line M is pulled out from the inside of the protector 50, wherefore the application of a load to the connected parts of the temperature detection lines 41 and the second circuit board 24 can be suppressed.

### Other Embodiments

(1) Although the protector 50 is provided with the protector body 50A and the covers 50B in the above embodiment, there is no limitation to this and a protector may be composed of one member.
(2) Although the first circuit boards 21 and the second circuit board 24 are flexible boards in the above embodiment, there is no limitation to this and first and second circuit boards may be rigid boards.
(3) Although the extra length portion M2 is illustrated to have the curved shape bulging in the direction toward the busbar accommodating portion 51 in the above embodiment, the shape of an extra length portion is not limited to this. For example, an extra length portion only has to be shaped to be stretchable in the first direction and may have a coil shape or a wave shape.
(4) Although the temperature detection lines 41 are illustrated to be accommodated in the detection line accommodation grooves 59A in the above embodiment, the temperature detection lines 41 may be partially accommodated in the detection line accommodation grooves 59A without contacting the main line M.
(5) Although the wiring module 20 provided with only one second circuit board 24 is illustrated in the above embodiment, a wiring module may be provided with a plurality of the second circuit boards 24.

### List of Reference Numerals

1: vehicle, 2: power storage pack, 3: PCU, 4: wiring harness
10: power storage module, 11: power storage element, 11G: power storage element group, 11T: electrode terminal, 15: small metal piece
20: wiring module, 21: first circuit board (circuit board), 22: board body, 22A: wire land, 23: extending portion, 24: second circuit board (circuit board), 25: board body, 25A: wire land, 26: temperature measuring element
30: busbar, 30A: connection busbar, 30B: output busbar
40: voltage detection line, 41: temperature detection line
50: protector, 50A: protector body, 50B: cover, 51: busbar accommodating portion, 52: main line accommodating portion, 52A: bottom wall, 52B: side wall, 52C: cut portion, 52D: curved wall, 53: board accommodating portion, 54: placing surface, 55: connector accommodating portion, 56: lead-out opening, 57: partition wall, 57A: opening, 58: fixing portion, 59: routing rib, 59A: detection line accommodation groove
60: connector
M: main line, M1: straight portion, M2: extra length portion, M1R: straight routing region, M2R: extra length routing region

1. A wiring module to be attached to a power storage element group configured by arranging a plurality of power storage elements including electrode terminals in a first direction, comprising:
a plurality of busbars;
a plurality of circuit boards;
a plurality of voltage detection lines;
a protector for holding the plurality of busbars, the plurality of circuit boards and the plurality of voltage detection lines; and
a connector located outside the protector,
the busbar being connected to the electrode terminal,
the circuit board being connected to the busbar,
one end of the voltage detection line being connected to the circuit board and the other end of the voltage detection line being connected to the connector,
a main line accommodating portion for accommodating a main line integrally configured by bundling the plurality of voltage detection lines and a fixing portion for fixing the main line to the protector being provided inside the protector,
the main line including a straight portion extending in the first direction and an extra length portion formed by contracting a part of the straight portion in the first direction, and
the main line accommodating portion including a straight routing region for routing the straight portion, a lead-out opening for leading out the main line from inside of the protector and an extra length routing region for routing the extra length portion by being disposed between the lead-out opening and the fixing portion.

2. The wiring module of claim 1, wherein:
the protector includes a busbar accommodating portion for accommodating the plurality of busbars and a board accommodating portion for accommodating the circuit boards by being disposed between the main line accommodating portion and the busbar accommodating portion and the extra length portion has a curved shape bulging in a direction toward the busbar accommodating portion, and
the extra length routing region is located between the fixing portion and the circuit board.

3. The wiring module of claim 2, wherein:
the plurality of circuit boards are accommodated in the board accommodating portion, and
the extra length routing region is located between the N^{th} circuit board and the (N+1)^{th} circuit board counted from the lead-out opening side.

4. The wiring module of claim 3, further comprising a temperature detection line,
wherein:
the plurality of circuit boards include a first circuit board to be connected to the busbar and a second circuit board having a temperature measuring element mounted thereon,
a plurality of the first circuit boards and the second circuit board are accommodated in the board accommodating portion,
one end of the temperature detection line is connected to the second circuit board and the other end of the temperature detection line is connected to the connector,
the main line is integrally configured by bundling the plurality of voltage detection lines and the temperature detection line,
a routing rib projecting in a second direction orthogonal to the first direction is provided on a bottom wall of the main line accommodating portion, and
the main line is routed away from the bottom wall of the main line accommodating portion in the second direction by the routing rib and the temperature detection line is routed between the main line and the bottom wall of the main line accommodating portion in the second direction.
